(19) United States
(12) Patent Application Publication
(10) Pub. No.: US 2010/0161776 A1
(43) Pub. Date: Jun. 24, 2010

(54) METHOD FOR REMOTELY PROVIDING SOFTWARE TO COMPUTING APPARATUS IN DISTRIBUTED COMPUTER NETWORK

(76) Inventors: Brian Hamner, Georgetown, KY (US); David Hay, Lexington, KY (US); Matt King, Lexington, KY (US); Mark Vance, Winchester, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 12/339,616

(22) Filed: Dec. 19, 2008

(51) Int. Cl. G06F 15/16

(52) U.S. Cl. 709/222

(57) ABSTRACT

Disclosed are a method and a computer program product for providing required software to at least one computing apparatus in a distributed computer network. The at least one computing apparatus is communicably coupled to at least one interfacing node of the distributed computer network. The method for providing the required software includes initiating a connection between the at least one interfacing node and a remote web server communicably coupled to the at least one interfacing node. The method further includes providing an address identifier data of the at least one computing apparatus to the at least one interfacing node. Furthermore, the method includes establishing a communication channel between the remote web server and the at least one computing apparatus through the at least one interfacing node. Moreover, the method includes receiving the required software at the at least one computing apparatus by utilizing the communication channel.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Disclosure

The present disclosure relates generally to distributed computer networks and more particularly to a method for remotely providing software to at least one computing apparatus in a distributed computer network.

2. Description of the Related Art

Computing apparatuses are widely used by people for performing a plurality of jobs at their homes as well as at their offices. The computing apparatuses may include a desktop computer, a server computer, a notebook computer, and the like. Moreover, some of the modern day peripheral devices such as an imaging apparatus are also capable of carrying out complex computations and processing data, similar to a computer, and accordingly may be included in the category of computing apparatuses. The plurality of jobs carried out by conventional computing apparatuses may include data processing, data storage, printing, scanning, copying, and the like.

Generally, a conventional computing apparatus includes a plurality of software that manages and performs the various operations of the computing apparatus. More specifically, the plurality of software may include system software such as operating systems, device drivers and the like, application software such as word processors and text editors and programming software such as compilers, interpreters, linkers, debuggers, and the like. Each of the plurality of software is deployed on the computing apparatus and is adapted to provide a specific functionality to the computing apparatus. Also, for the purpose of providing improved functionality or additional features to the existing functionality of the computing apparatus, it may be desirable to replace at least one of the plurality of software with upgraded software from time to time.

Generally, software required by computing apparatuses is deployed thereon in an open loop fashion. More specifically, the software may be provided in a distributable form, such as an executable binary file, by a “distributor” of the software, such as a proprietor of the software, to a “control agent” adapted to control the computing apparatus. The “control agent” may be a person or a mechanism that has access rights to the computing apparatus. The distributable form of software may be provided by the distributor in a portable storage medium, such as a compact disc (CD), through the Internet or through any other means known in the art. However, it will be evident to a person skilled in the art that there may be other methods of deployment of the software to the computing apparatus.

In a typical distributed computer network environment having a plurality of computing apparatuses communicably coupled to each other, a control agent of the plurality of computing apparatuses may store the distributable form of the software on a specific computing apparatus and thereafter deploy the software on other computing apparatuses. Accordingly, the onus of the deployment of the software on the computing apparatuses rests with the control agent. The distributor is not apprised of the status of deployment of the software on the computing device, and as such, has no control over the distribution of the software once the software is provided to the control agent. Moreover, the deployment of the software in the open loop fashion requires presence of a skilled control agent to effectively undertake the deployment, thereby potentially increasing the cost of deployment of the software.

Accordingly, there persists a need for a method for providing a software to a computing apparatus in a distributed computer network that overcomes the drawbacks and limitations of prior art. More specifically, there persists a need for a method for providing software to a computing apparatus in a distributed computer network that provides control over the distribution thereof to a distributor of the software. There further persists a need for a method for providing software to a computing apparatus in a distributed computer network that eliminates the need of employing a skilled control agent for deploying the software on the computing apparatus. Moreover, there persists a need for a method that deploys software to a computing apparatus in a distributed computer network in an easy, economical, and time efficient manner.

### SUMMARY OF THE DISCLOSURE

In view of the foregoing disadvantages inherent in the prior art, the general Is purpose of the present disclosure is to provide a method for providing a required software to a computing apparatus in a distributed computer network by including all the advantages of the prior art, and overcoming the drawbacks inherent therein.

Accordingly, in one aspect, the present disclosure provides a method for providing required software to at least one computing apparatus in a distributed computer network. The at least one computing apparatus is communicably coupled to at least one interfacing node of the distributed computer network. The method for remotely providing the required software includes initiating a connection between the at least one interfacing node and a remote web server communicably coupled to the at least one interfacing node. The remote web server is adapted to provide the required software. The method further includes receiving an address identifier data of the at least one computing apparatus at the at least one interfacing node. Furthermore, the method includes establishing a communication channel between the remote web server and the at least one computing apparatus through the at least one interfacing node. Moreover, the method includes receiving the required software at the at least one computing apparatus by utilizing the communication channel.

In yet another aspect, the present disclosure provides a computer program product embodied on a computer readable medium for remotely providing required software to at least one computing apparatus in a distributed computer network. The at least one computing apparatus is communicably coupled to at least one interfacing node of the distributed computer network. The computer program product includes a program module having a set of instructions for initiating a connection between the at least one interfacing node and a remote web server communicably coupled to the at least one interfacing node, wherein the remote web server is adapted to provide the required software. The program module also includes a set of instructions for providing an address identifier data of the at least one computing apparatus to the at least one interfacing node. Further, the program module includes a set of instructions for establishing a communication channel between the remote web server and the at least one computing apparatus through the at least one interfacing node. Moreover, the program module also includes a set of instructions for receiving the required software at the at least one computing apparatus by utilizing the communication channel.

### BRIEF DESCRIPTION OF THE DRAWINGS

The above-mentioned and other features and advantages of the present disclosure, and the manner of attaining them, will become more apparent and the disclosure will be better understood by reference to the following description of embodiments of the present disclosure taken in conjunction with the accompanying drawings, wherein:

FIG. 1A illustrates an exemplary distributed computer network in which the present disclosure is utilized, in accordance with an embodiment of the present disclosure;

FIG. 1B illustrates an exemplary distributed computer network in which the present disclosure is utilized, in accordance with another embodiment of the present disclosure; and

FIG. 2 illustrates a method for remotely providing required software to at least one computing apparatus in distributed computer network of FIG. 1A, in accordance with an embodiment of the present disclosure.

### DETAILED DESCRIPTION

It is to be understood that the disclosure is not limited in its application to the details of construction and the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected” and “coupled,” and variations thereof herein are used broadly and encompass direct and indirect connections and couplings. In addition, the terms “connected” and “coupled” and variations thereof are not restricted to physical or mechanical connections or couplings.

In addition, it should be understood that embodiments of the disclosure include both hardware and electronic components or modules that, for purposes of discussion, may be illustrated and described as if the majority of the components were implemented solely in hardware.

However, one of ordinary skill in the art, and based on a reading of this detailed description, would recognize that, in at least one embodiment, the method disclosed in the disclosure may be implemented in software. As such, it should be noted that a plurality of hardware and software-based devices, as well as a plurality of different structural components may be utilized to implement the disclosure. Furthermore, and as described in subsequent paragraphs, the specific configurations illustrated in the drawings are intended to exemplify embodiments of the disclosure and other alternative configurations are possible.

The present disclosure provides a method for providing required software to at least one computing apparatus in a distributed computer network. The term “required software” as described herein, refers to software that is desired to be installed on at least one computing apparatus. The required software may be selected by a control agent that may have access rights of at least one computing apparatus. Further, the required software may include firmware of the computing apparatus, application software for the computing apparatus, and software for updating configuration data of the computing apparatus. For example, application software for a computing apparatus, such as an imaging apparatus, includes software that receives an image from the scanner of the imaging apparatus, performs processing of the image and delivers the processed image to a destination external to the imaging apparatus. However, it will be evident to a person skilled in the art that the required software may also include other types of software, such as operating systems, drivers, programming languages and the like.

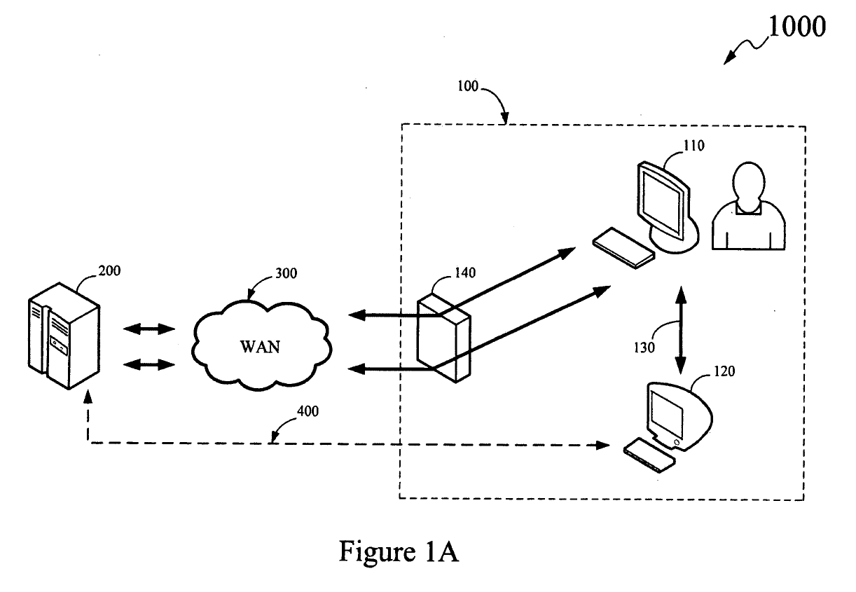

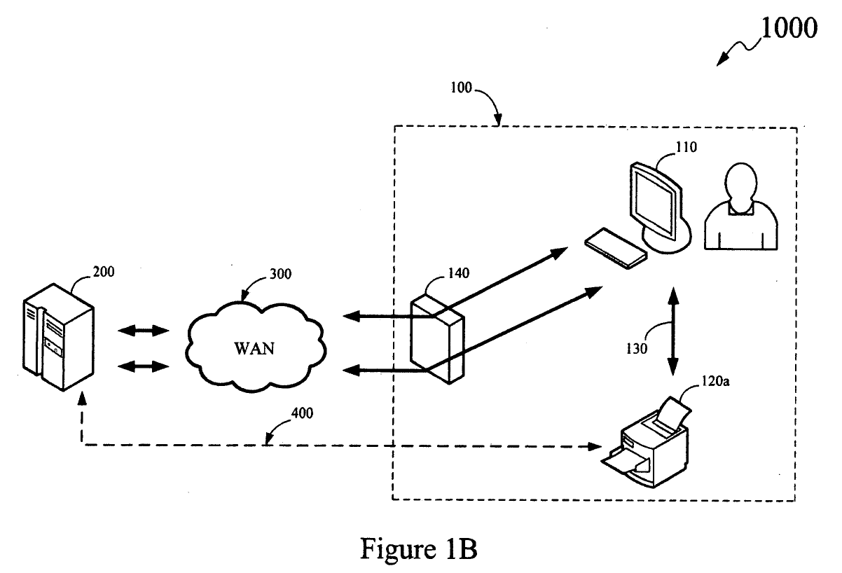

Referring to FIG. 1A, an exemplary distributed computer network 1000 in which the present disclosure is utilized is illustrated. Distributed computer network 1000 hereinafter referred to as “network 1000”) may include a network having a plurality of computing apparatuses such as client computers and server computers that may communicate with each other. It will be evident to a person skilled in the art that network 1000 may be implemented using a Local Area Network (LAN), a Wide Area Network (WAN) and the like. Referring now to FIG. 1A, network 1000 includes an enterprise network 100 and a remote web server 200 communicably coupled to enterprise network 100 over a WAN 300. Without limiting the scope of the present disclosure, WAN 300 may include the Internet or World Wide Web. Further, remote web server 200 includes a plurality of software preferably stored in a data repository thereof. The plurality of software stored in the data repository may include an operating system, application software, device drivers, firmware, software for updating configuration data and the like. The required software for computing apparatuses may be selected from the plurality of software stored at remote server 200. Remote web server 200 may thereafter provide the required software to enterprise network 100 over WAN 300. In an embodiment of the present disclosure, remote web server 200 may be a server computer located in an enterprise network of a distributor of the required software.

As shown in FIG. 1A, enterprise network 100 includes at least one interfacing node, such as an interfacing node 110 and at least one computing apparatus, such as a computing apparatus 120 communicably coupled to interfacing node 110. Computing apparatus 120 may be communicably coupled to interfacing node 110 over a LAN 130. However, it will be evident to a person skilled in the art that the communicable coupling between computing apparatus 120 and interfacing node 110 may also be provided over a WAN. Interfacing node 110 may be adapted to perform functions of a control agent and accordingly may have access rights over at least one computing apparatus 120. Interfacing node 110 may be a personal computer, a server computer, a notebook computer, Personal Digital Assistant (PDA) and the like. Further, computing apparatus 120 may be a desktop computer, a notebook computer, a server computer, a multi-function device and the like. In a preferable embodiment of the present disclosure, computing apparatus 120 may include an imaging apparatus such as an imaging apparatus 120a, as illustrated in FIG. 1B. The imaging apparatus 120a may include a scanner device, a printer device, a multi-function device and the like.

Further, enterprise network 100 may include a firewall 140 for enabling communicable coupling between enterprise network 100 and remote web server 200 over WAN 300. More specifically, firewall 140 enables interfacing node 110 to access remote web server 200 over WAN 300. Firewall 140 may be a hardware device or a software installed on a computer that restricts data traffic between enterprise network 100 and WAN 300.

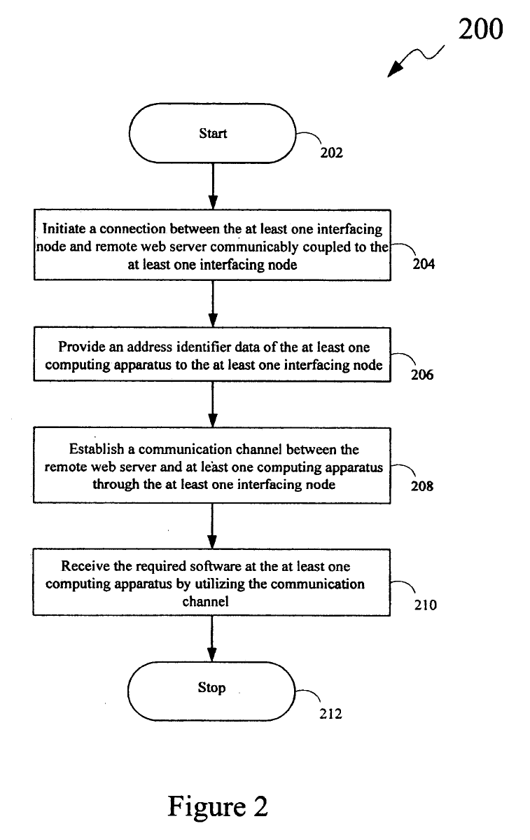

In operation, interfacing node 110 is adapted to communicate with remote web server 200 for receiving the required software therefrom, which in turn may be provided to computing apparatus 120 through LAN 130. Interfacing node 110 includes an internet client such as a web browser application (not shown) that enables a user to access remote web server 200 for receiving the required software therefrom, over WAN 300. A method for providing the required software to computing apparatus 120 may be explained in detail in conjunction with FIG. 2.

Referring now to FIG. 2, a flow diagram illustrating a method for remotely providing the required software to computing apparatus 120 in network 1000 is provided, in accordance with an embodiment of the present disclosure. The method for remotely providing the required software commences at 202. At 202, a user having access to interfacing node 110 may query computing apparatus 120 for determining software already installed on computing apparatus 120. Such a determination may enable the user to select the required software for computing apparatus 120 from remote server 200. Further, a connection between interfacing node 110 and remote web server 200 is initiated at 204. More specifically, the user may utilize the web browser provided in interfacing node 110 to access remote server 200. Particularly, the web browser may access a web page communicably coupled to remote web server 200. In an embodiment of the present disclosure, the web page may be stored in a data repository of remote web server 200. The web page may be adapted to display a list of software stored in the data repository of remote web server 200. The user at interfacing node 110 may select the required software for computing apparatus 120 from the list of software displayed on the web page. In an embodiment of the present disclosure, selection of the required software may be based on the determination of the software already installed on computing apparatus 120 performed at 202.

Further, upon selection of the required software from the web page, a request message is transmitted to remote web server 200 for providing required software to interfacing node 110. Thereafter, the web page may initiate an application module (not shown) at interfacing node 110. The application module may be initiated on the web browser of interfacing node 110. In an embodiment of the present disclosure, the application module may be a Java applet, ActiveX control or a Rich Internet Application. The application module may be communicably coupled to remote web server 200 and configured to exchange data between remote web server 200 and computing apparatus 120 through interfacing node 110. Particularly, the application module is adapted to facilitate communication between remote web server 200 and computing apparatus 120 through interfacing node 110. More specifically, the application module is configured to accept an address identifier data of computing apparatus 120 from the user at interfacing node 110, for establishing communication between remote web server 200 and computing apparatus 120. In an embodiment of the present disclosure, the address identifier data of computing apparatus 120 may include an Internet Protocol (IP) address thereof. Additionally, the application module may be configured to acquire information regarding all of the computing apparatuses, such as computing apparatus 120, communicably coupled to interfacing node 110. The application module may provide such information to remote web server 200.

Further, at 206, the address identifier data of computing apparatus 120 is provided to the application module. The address identifier data may be provided at interfacing node 110 by the user.

Upon providing the address identifier data of computing apparatus 120 to the application module, a communication channel 400 (shown in FIG. 1A) is established between remote web server 200 and computing apparatus 120 through interfacing node 110. At 208, the application module at interfacing node 110 utilizes the address identifier data of computing apparatus 120 to establish a first communication channel (not shown) between computing apparatus 120 and interfacing node 110. In an embodiment of the present disclosure, the application module may traverse LAN 130 to discover computing apparatus 120 identified by the address identifier data and establish the first communication channel therewith. The first communication channel uses a first communication protocol to facilitate communication between computing apparatus 120 and interfacing node 110. In an embodiment of the present disclosure, the first communication protocol may utilize Transmission Control Protocol (TCP) or any other network communication protocol able to communicate between a computing apparatus 120 and application module. In an alternate embodiment of the present disclosure, the first communication protocol may utilize the Universal Serial Bus protocol, Firewire or Bluetooth or any other direct communication protocol able to communicate between a computing apparatus 120 and the application module.

In an exemplary embodiment of the present invention, upon establishment of the first communication channel, the application module may retrieve configuration details and status information of computing apparatus 120. The configuration details of computing apparatus 120 refer to information regarding software already present on computing apparatus 120 and settings for said software that exist on computing apparatus 120. Further, the configuration details may also refer to information regarding hardware components of computing apparatus 120. Furthermore, the status information of computing apparatus 120 refers to a current working state of computing apparatus 120. More specifically, the status information of computing apparatus 120 indicates the availability of computing apparatus 120 to carry out an intended task.

The configuration details and the status information of computing apparatus 120 may be used for multiple purposes. Some of the following examples indicate the usage of the configuration details and the status information of computing apparatus 120. However, these examples should not be considered as limiting the scope of the present disclosure. The status information of computing apparatus 120 may be used to determine whether or not computing apparatus 120 is in a state to receive and process a software update. Further, the configuration details and the status information of computing apparatus 120 may be used to determine presence of any software updates such as a firmware update that may be required to support the requested required software deployment. Furthermore, the configuration details and status information may be used to determine presence of any software or configuration presently existing on computing apparatus 120 that may conflict with the required software requested by the user. The application module may utilize the retrieved configuration details and status information to make a decision regarding providing the required software to computing apparatus 120.

Further, the application module is also configured to facilitate communication between remote web server 200 and interfacing node 110 using a second communication channel. The second communication channel may utilize a second communication protocol to facilitate communication between remote web server 200 and interfacing node 110. In an embodiment of the present disclosure, the second communication protocol may utilize a Hyper Text Transfer Protocol over a Secure Socket layer (HTTPS). Accordingly, the application module is configured to communicate over different types of communication protocols at the same time, thereby enabling computing apparatus 120 and remote web server 200 to share information or transfer data through the application module.

Referring again to FIG. 2. At 210, the required software selected by user at 204, is received at computer apparatus 120 by utilizing communication channel 400. More specifically, upon establishment of communication channel 400 between remote web server 200 and computing apparatus 120, remote web server 200 provides the required software to computing apparatus 120 through communication channel 400 established by the application module. The application module may make a decision regarding providing the required software to computing apparatus 120 based on the configuration details and the status information retrieved by the application module from computing apparatus 120. For example, the application module may check for an appropriate time for providing the required software when computing apparatus 120 is substantially idle. In another example, the application module may check for the presence of any conflicting software already present on computing apparatus 120 and accordingly, provide an indication regarding the conflict with the required software to the user on interfacing node 110.

Further, in an embodiment of the present disclosure, the required software may be received in a memory device of computing apparatus 120. The memory device may include a flash memory, a Random Access memory (RAM), and the like. After receiving the required software at computing apparatus 120, the application module may undertake deployment of the required software at computing apparatus 120. For example, in the event the required software includes software for updating configuration data, the software is executed on computing apparatus 120 to update configuration data settings of computing apparatus 120. In another example, in event that the required software includes a new version of a firmware for computing apparatus 120, the application module replaces an older version of the firmware of computing apparatus 120 with a new version of the firmware. Thereafter, the method for providing the required software to computing apparatus 120 concludes at 212. In an embodiment of the present disclosure, a status of a deployment of the required software, such as a failed or a successful deployment at computing apparatus 120 may be provided to remote web server 200 at 212. Information regarding the status of the deployment may be accessed by the distributor of the required software, thereby enabling the distributor to have control over the distribution of the required software.

The method of the present embodiment may be implemented in a computer network in the form of software. Accordingly, in an embodiment of the present disclosure, a computer program product is provided for enabling required software to be remotely provided to at least one computing apparatus, such as computing apparatus 120, communicably coupled to at least one interfacing node, such as interfacing node 110, in a distributed computer network, such as network 1000. The computer program product is embodied on a computer readable storage medium and includes a program module having a set of instructions for initiating a connection between at least one interfacing node and a remote web server, such as remote web server 200, communicably coupled to at least one interfacing node. More specifically, the set of instructions for initiating the connection between at least one interfacing node and the remote web server includes a set of instructions for accessing a web page that is communicably coupled to remote web server, requesting required software from the remote web server and initiating an application module associated with the remote web server at the at least one interfacing node. The application module may be utilized for providing an address identifier data of at least one computing apparatus to at least one interfacing node.

Further, the program module includes a set of instructions for providing an address identifier data of at least one computing apparatus to at least one interfacing node. Furthermore, the program module includes a set of instructions for establishing a communication channel between the remote web server and the at least one computing apparatus through the at least one interfacing node. Moreover, the program module includes a set of instructions for receiving the required software at the at least one computing apparatus by utilizing the communication channel.

Accordingly, the present disclosure provides a method that may be utilized effectively for remotely providing required software to at least one computing apparatus in a distributed computer network. In the disclosed method, the deployment of the required software is carried out by an application module associated with remote web server. Accordingly, the disclosed method provides a control to a distributor of the required software over distribution thereof, by enabling distributor to be apprised of a status of deployment of the required software. Further, since the deployment of the required software is controlled by the application module, a requirement for a skilled control agent, such as a person or a mechanism, for the deployment of the required software at the computing apparatus is precluded. Accordingly, the disclosed method is easy, reliable, cost-effective and time efficient.

The foregoing description of several methods of the present disclosure has been presented for purposes of illustration. It is not intended to be exhaustive or to limit the disclosure to the precise actions and/or forms disclosed, and obviously many modifications and variations are possible in light of the above teaching. It is intended that the scope of the disclosure be defined by the claims appended hereto.

What is claimed is:

1. A method for remotely providing required software to at least one computing apparatus in a distributed computer network, the at least one computing apparatus being communicably coupled to at least one interfacing node of the distributed computer network, comprising:
initiating a connection with a remote web server communicably coupled to the at least one interfacing node, the remote web server adapted to provide the required software;
receiving an address identifier data of the at least one computing apparatus;
establishing a communication channel between the remote web server and the at least one computing apparatus through the at least one interfacing node; and
receiving the required software at the at least one computing apparatus by utilizing the communication channel.

2. The method of claim 1, wherein the at least one interfacing node comprises a web browser for enabling the initiation of the connection between the remote web server and the at least one interfacing node.

3. The method of claim 1, wherein the address identifier data of the at least one computing apparatus comprises an Internet Protocol (IP) address of the at least one computing apparatus.

4. The method of claim 1, wherein initiating the connection with the remote web server comprises:
accessing a web page communicably coupled to the remote web server;
requesting the required software from the remote web server by utilizing the web page; and
initiating an application module associated with the web page for receiving the address identifier data of the at least one computing apparatus.

5. The method of claim 4, wherein the application module is a Java applet.

6. The method of claim 1, wherein the required software comprises at least one of one or more firmware of the at least one computing apparatus, one or more application software and one or more software for updating configuration data of the at least one computing apparatus.

7. The method of claim 4, further comprising deployment of the software on the at least one computing apparatus by the application module upon receiving the required software at the at least one computing apparatus.

8. The method of claim 1, wherein the at least one computing apparatus is an imaging apparatus.

9. The method of claim 1, wherein the at least one interfacing node is a computer.

10. A computer program product embodied on a computer readable storage medium remotely providing required software to at least one computing apparatus in a distributed computer network, the at least one computing apparatus being communicably coupled to at least one interfacing node of the distributed computer network, the computer program product comprising a program module having a set of instructions for:
initiating a connection between the at least one interfacing node and a remote web server communicably coupled to the at least one interfacing node, the remote web server adapted to provide the required software;
receiving an address identifier data of the at least one computing apparatus at the at least one interfacing node;
establishing a communication channel between the remote web server and the at least one computing apparatus through the at least one interfacing node; and
receiving the required software at the at least one computing apparatus by utilizing the communication channel.

11. The computer program product of claim 10, wherein the at least one interfacing node comprises a web browser for enabling the initiation of the connection between the remote web server and the at least one interfacing node.

12. The computer program product of claim 10, wherein the address identifier data of the computing apparatus comprises an Internet Protocol (IP) address of the at least one computing apparatus.

13. The computer program product of claim 10, wherein initiating the connection between the at least one interfacing node and the remote web server comprises:
accessing a web page communicably coupled to the remote web server at the at least one interfacing node;
requesting the required software from the remote web server by utilizing the web page; and
initiating an application module associated with the web page at the at least one interfacing node for providing the address identifier data of the at least one computing apparatus to the at least one interfacing node.

14. The computer program product of claim 13, wherein the application module is a Java applet.

15. The computer program product of claim 10, wherein the required software comprises at least one of one or more firmware of the at least one computing apparatus, one or more application software and one or more software for updating configuration data of the at least one computing apparatus.

16. The computer program product of claim 13 further comprising a set of instructions for deployment of the software on the at least one computing apparatus by the application module upon receiving the required software at the at least one computing apparatus.

17. The computer program product of claim 10, wherein the at least one computing apparatus is an imaging apparatus.

18. The computer program product of claim 10, wherein the at least one interfacing node is a computer.
